(19) United States
(12) Patent Application Publication
(10) Pub. No.: US 2026/0110790 A1
(43) Pub. Date: Apr. 23, 2026

(54) SYSTEM AND METHOD FOR SPIN NORMALIZATION

(71) Applicant: Applied Concepts, Inc., Richardson, TX (US)

(72) Inventors: Jared Smothermon, Lucas, TX (US); James Kevin McCoy, Garland, TX (US)

(73) Assignee: Applied Concepts, Inc., Richardson, TX (US)

(21) Appl. No.: 18/918,321

(22) Filed: Oct. 17, 2024

(51) Int. Cl. G01S 13/50; G01S 7/35

(52) U.S. Cl. CPC G01S 13/50; G01S 7/352

(57) ABSTRACT

A method for determining spin of an object comprising transmitting an electromagnetic signal towards the object from a transmitter, receiving a reflected signal from the object, performing a correlation process on the reflected signal using the reflected signal to generate a plurality of estimates, normalizing the plurality of the estimates and generating an estimate of the spin of the object as a function of the normalized plurality of the estimates.

### TECHNICAL FIELD

The present disclosure relates generally to spin detection, and more specifically to a system and method for spin normalization that improves the accuracy of spin detection.

### BACKGROUND OF THE INVENTION

Detection of the spin of an object is known but is difficult to accomplish due to noise.

### SUMMARY OF THE INVENTION

A method for determining spin of an object is disclosed. The method includes transmitting an electromagnetic signal towards the object from a transmitter and receiving a reflected signal from the object. A correlation process is performed on the reflected signal using the reflected signal to generate a plurality of estimates, and the plurality of the estimates is normalized. An estimate of the spin of the object is generated as a function of the normalized plurality of the estimates.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of an algorithm for spin detection, in accordance with an example embodiment of the present disclosure; and

FIG. 2 is a diagram of a system for spin detection, in accordance with an example embodiment of the present disclosure.

### DETAILED DESCRIPTION OF THE INVENTION

In the description that follows, like parts are marked throughout the specification and drawings with the same reference numerals. The drawing figures may be to scale, and certain components can be shown in generalized or schematic form and identified by commercial designations in the interest of clarity and conciseness.

The present disclosure relates to systems and methods for measuring spin. In one example embodiment, the magnitude of a reflected radio frequency (RF) signal can be used in combination with autocorrelation. Electromagnetic radiation is known to interact with stationary objects, moving objects, spinning objects and other suitable objects. An autocorrelation-based method of measuring the spin of an object is described, based on the following assumptions. First, it is assumed that the received signal is reflected from an object that is seen by the radar. At each moment as the object spins, the radar “sees” a “different” object. Once the object has made a complete rotation, the object “looks” to the radar as it did one complete rotation prior. With this perspective, and assuming the received signal that represents what the radar is “seeing” at any given time is described as x(t), then x(t) is a periodic signal with a period corresponding to the time it takes to make a complete rotation of the object.

If the received signal is defined as:

$$x ( t ) \qquad ( 1 )$$

then, assuming the simplified condition that the object is spinning about an axis of rotation that is fixed with respect to the radar device and assuming the distance from the object to the radar is also fixed, then the received signal is periodic:

$$x ( t ) = x ( t - τ ) \qquad ( 2 )$$

where τ represents the amount of time it takes for the object to make a complete rotation. Given the above relationship, any suitable process can be used to discover τ. The present disclosure uses a variation of the autocorrelation function to discover the value of τ in one example embodiment.

The autocorrelation function can be defined in various ways. One way is as follows:

$$r ( τ ) = \sum x ( t ) x ( t - τ ) \qquad ( 3 )$$

where the summation is made over t. This function r(τ) is computed for different values of τ and then the value of τ for which r(τ) is maximum corresponds to the value of τ that is inversely proportional to the spin rate of the object. For example, consider the example of a spin rate that is defined by a sine wave with maximum amplitude of 1 and a minimum amplitude of −1. For the following values of t, τ and N=4, the autocorrelation function correctly predicts the spin rate of 1 rpm (i.e. 2π):

| t | X (t) |
|---|---|
| −2π | 0 |
| −3π/2 | 1 |
| −π | 0 |
| −π/2 | −1 |
| 0 | 0 |
| π/2 | 1 |
| Π | 0 |
| 3π/2 | −1 |
| 2π | 0 |

| τ | Σ × (t) × (t − τ), from 90° to 360° | r (τ) |
|---|---|---|
| π/2 | 1*0 + 0*1 + (−1) *0 + 0* (−1) | 0 |
| Π | 1* (−1) + 0*0 + (−1) *1 + 0*0 | −2 |
| 3π/2 | 1* (0) + 0* (−1) + (−1) *0 + 0*1 | 0 |
| 2π | 1*(1) + 0*0 + (−1) * (−1) + 0*0 | 2 |

As can be seen, the maximum value is found at τ=2π, which is the known spin rate for a sinusoidal signal. However, the accuracy of the step size only permits the spin rate to be estimated to within 3π/2 to 5π/2. A step size for τ should be selected that is sufficiently small to obtain the desired accuracy.

When the axis of rotation is changing with respect to the radar signal receiver, if the axis of rotation is changing slowly compared to spin rate of the object, the assumption above still approximately holds. Similarly, if the object is changing position with respect to the radar signal receiver, the assumption still approximately holds. In other words, finding t by using some variant of an autocorrelation still finds the correct estimate for the spin rate of the object because the salient feature of the received signal is the periodic nature of the signal, even though each period is slightly different from the others due to noise, changes in position, changes in axis of rotation, and other changes. The present disclosure presents a way to preprocess the data and to normalize the autocorrelation and score the “goodness” of the spin measurement.

Data preprocessing can be performed by defining a signal x(t) to be a time varying complex signal with real and imaginary components. The signal is received by the radar antenna and is a measurement of the electromagnetic energy received by the radar antenna that has been mixed (heterodyned) with the signal that is transmitted by the antenna. The received signal contains frequency components related to moving objects in the field of view of the radar. The most salient component is that which corresponds to the Doppler shift (proportional to the speed of flight) of the spinning projectile (e.g. baseball).

Some of the information in the received signal that relates to spin is centered around the frequency of the Doppler shift corresponding to the speed of the projectile. The spinning projectile will also slow down because of friction as it travels through a medium (e.g. air) causing the frequency of the Doppler-shifted signal to become lower during the travel of the projectile. And because the information content of interest for spin is centered about and close to the Doppler shift frequency, then to maximize the signal to noise ratio (SNR), all frequency content that is outside of this band can be filtered out. This frequency content is changing over time, so a traditional band pass filter is not the best solution because the pass band needs to be wide, so as to include the start of the projectile path all the way to the end of the projectile path. That is not an optimal configuration, because all frequencies that are included that are not part of the spin information are noise as far as the spin is concerned and including them results in a lower SNR. One way to address this constraint is to first remove the changing Doppler shift (high to low based on the slowing down of the projectile), and then to filter the signal.

Because the frequency corresponding to the Doppler shift will shift downward as the projectile slows down, the amount of frequency shift will be dependent on the initial speed of the projectile, as well as the material/composition of the projectile, the medium in which it is traveling and other physical parameters. A suitable technique to remove the changing Doppler shift can be used to allow spin detection to be unaffected by the differences in projectile speed, composition or other factors. In one example embodiment, the complex signal x(t) can be heterodyned with a complex signal c(t) that is generated to specifically nullify the frequency shift (chirp) seen in the original x(t). Mathematically, that process can be defined by the following operation:

$$y ( t ) = x ( t ) * c ( t )$$

In this example embodiment, c(t) can be selected so that the dominant (Doppler) frequency along the path of the projectile is rotated to zero Hz (i.e. DC). This rotation can be accomplished in real-time by estimating the Doppler shift frequency during the flight of the projectile or after the fact (if the signal can be stored in memory for subsequent processing). If the starting Doppler frequency and ending Doppler frequency for the flight of the projectile are known, then c(t) can be defined as:

```
freq = firstfreq
phase = 0
deltafreq = (lastfreq−firstfreq) / (NUM_SAMPLES)
for each sample, j=1,2,3...NUM_SAMPLES {
  deltaphase = freq * RADIANS_PER_SAMPLE
  freq += deltafreq
  phase += deltaphase
  c(j) = cos(phase)−sin(phase)*sqrt(−1)
  y(j) = x(j) * c(j)
}
```

After the energy (information) of interest in the signal has been brought down to DC or close to DC, a simple low pass filter will suffice to remove the noise from the signal.

Spin detection and scoring can be accomplished as follows. After preprocessing the data as described above, the spin of the projectile that is related to the periodicity in the radar signal is detected. A function p(t) can be used to describe the preprocessed data.

As described above, the spin (RPM) is related to the periodicity in the signal and a suitable technique for estimating this can be used, such as autocorrelation of p(t). In an environment where the radar has a clear view of the spinning projectile and there are minimal noise sources, a simple autocorrelation can be used to obtain an estimate of the spin. However, in many real-world scenarios, there are many noise sources and that can render autocorrelation insufficient. The present disclosure avoids such problems by 1) using an average of multiple autocorrelations at different times in the flight of the projectile and 2) by normalizing the autocorrelation.

Average multiple autocorrelations can be taken during different segments of the flight of the projectile. For the example embodiment of a baseball, at the beginning of the flight of the baseball, there are reflected signals generated from the incident radar that encode energy from the action of the pitcher, and these can confound the autocorrelation operation. Towards the end of the flight of the baseball, the catcher and batter are moving, which can also confound the autocorrelation. Furthermore, items such as a backstop may be flapping in the breeze, or a number of other confounding signals can be generated by reflected radar signals. Taking an average at different segments of the flight of the ball helps to cause the spin-related signals to coherently average while the non-spin related noise signals do not.

After averaging the autocorrelation signals, additional advantages can be obtained by normalizing the averaged signals. Normalizing provides a unified/common way to pick the spin and to give it a score (i.e. confidence in the estimate) that can be used, irrespective of differences related to ball type, speed, flight duration and other physical parameters.

One process that can be used to normalize the autocorrelation signal is to divide it by a number that is computed as a function of the autocorrelation itself. In one example embodiment, the standard deviation of the autocorrelation is computed from 1) the lag corresponding to the fastest spin rate to 2) the lag corresponding to the slowest spin rate. A lag “k” autocorrelation is a correlation between values that are “k” time periods apart. Conceptually, in an ideal world the only information in the original signal p(t) will correspond to the spinning of the projectile, which would therefore be perfectly periodic. A periodic signal would yield a (lag) values (representing the energy in the signal) at integer multiples of the spin period lag, and zero energy at all other lags in the autocorrelation signal. In this ideal case, choosing the correct lag for spin would be easy. In the real world, the autocorrelation is much noisier. The standard deviation of the ideal case yields a small number, whereas the standard deviation for a very noisy autocorrelation yields a large number. Dividing the autocorrelation signal by the standard deviation scales the autocorrelation signal, so that the normalized autocorrelation is relatively independent of the length of the autocorrelation, magnitude of the original signal and so forth.

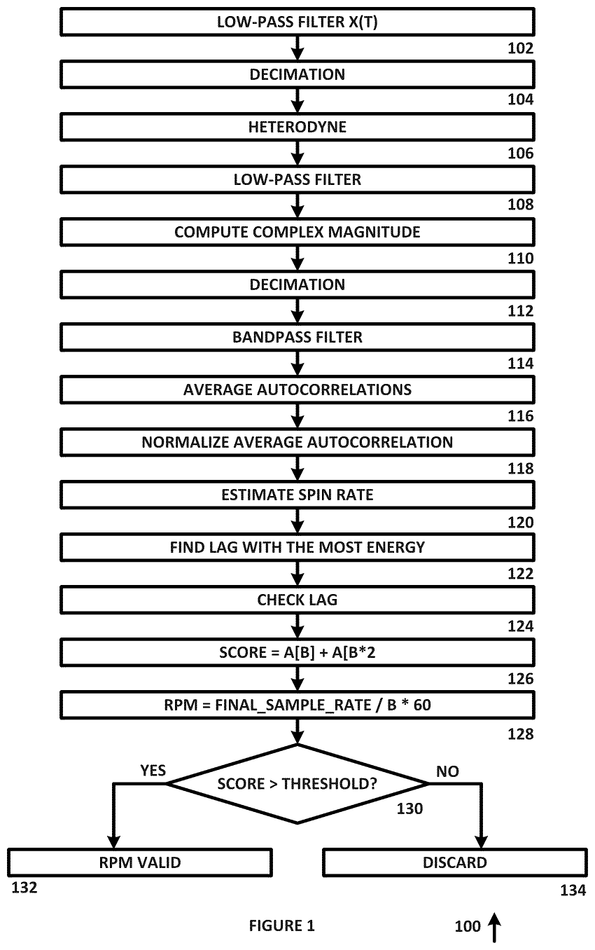

FIG. 1 is a diagram of an algorithm 100 for spin detection, in accordance with an example embodiment of the present disclosure. Algorithm 100 can be implemented in hardware or a suitable combination of hardware and software.

In this example embodiment, the radar signal x(t) can be generated using a continuous-wave Doppler radar that transmits a signal towards an object from an antenna and that receives a reflected signal from the object. The transmitted and reflected signals can be digitized, such as by sampling the signals at 192 kHz or other suitable sampling frequencies to generate two channel signals that are in phase quadrature. The digitized analog signal is the resultant of a hardware mixing process of the transmitted RF signal and the received reflected RF signal.

Algorithm 100 begins at 102, where the radar signal is processed with a low-pass filter LP(t). In one example embodiment, the low-pass filter can have a 16 kHz cutoff, the radar signal can be processed after it has been digitized, or other suitable processes can also or alternatively be used. The algorithm then proceeds to 104.

At 104, the filtered signal is decimated, such as by four to generate a 48 kHz signal. In one example embodiment, decimation can be accomplished by using every fourth sample and discarding the unused samples, or in other suitable manners. Other suitable levels of decimation can also or alternatively be used. The algorithm then proceeds to 106.

At 106, the signal is heterodyned with a signal c(t) to generate a resultant signal, such as computed as described above or in other suitable manners. In one example embodiment, the transmitted and received signals can be mixed or other suitable processes can also or alternatively be used. The algorithm then proceeds to 108.

At 108, the resultant signal is processed with a low-pass filter having a suitable cutoff frequency. In one example embodiment, the cutoff frequency can be 800 Hz or other suitable frequencies. The algorithm then proceeds to 110.

At 110, a complex magnitude of the resultant signal is computed. In one example embodiment, the complex magnitude can be computed using digital data processing or in other suitable manners. The algorithm then proceeds to 112.

At 112, the resultant signal is decimated, such as by ten to yield a 4.8 kHz signal or at other suitable decimation levels. In one example embodiment, the decimation can be performed by using every tenth sample or in other suitable manners. The algorithm then proceeds to 114.

At 114, the decimated signal is band-pass filtered, such as from 100 Hz to 1 kHz or over other suitable bands. In one example embodiment, the band-pass filtering can be computed using digital data processing or in other suitable manners. The algorithm then proceeds to 116.

At 116, the average of a predetermined number of autocorrelations is calculated. In one example embodiment, ten autocorrelation data sets can be averaged, or other suitable numbers can also or alternatively be used. The algorithm then proceeds to 118.

At 118, the average autocorrelation is normalized, such as by dividing the autocorrelation by its standard deviation or in other suitable manners. In one example embodiment, if the autocorrelation can be computed at multiple lags, the standard deviation can be computed over the set of autocorrelation values computed at the various lags, and each one of those autocorrelation values can then be divided by the computed standard deviation. The algorithm then proceeds to 120.

At 120, the spin rate is estimated. In one example embodiment, the spin rate can be estimated using steps 122 through 128 of algorithm 200 or in other suitable manners. The algorithm then proceeds to 122.

At 122, the lag with the most energy is found. In one example embodiment, the greatest number of integer multiples of the spin period lag (representing the energy in the signal) can be determined. The algorithm then proceeds to 124.

At 124, it is determined whether the lag at the second harmonic or b/2 is a strong peak even though it isn't the largest. If so, set b=b/2. This is a check for the special case where the second harmonic happens to be a bit larger than the fundamental. The algorithm then proceeds to 126.

At 126, a score is generated. In one example embodiment, the score can be a[b]+a[b*2]. The algorithm then proceeds to 128.

At 128, the RPM is calculated. In one example embodiment, the RPM can be determined as FINAL_SAMPLE_RATE/b*60. The algorithm then proceeds to 130.

At 130, it is determined whether the score is above a predetermined threshold. If so, the algorithm proceeds to 132 and the RPM measurement is selected as valid, otherwise the algorithm proceeds to 134 and RPM measurement is discarded due to being too noisy or unreliable.

In operation, algorithm 100 allows the RPM of a projectile to be calculated with higher accuracy using a normalization process. While algorithm 100 is shown as a flow chart, a person of skill in the art will recognize that it can also or alternatively be implemented using object-oriented programming, state diagrams, ladder diagrams other suitable programming paradigms or a suitable combination of programming paradigms.

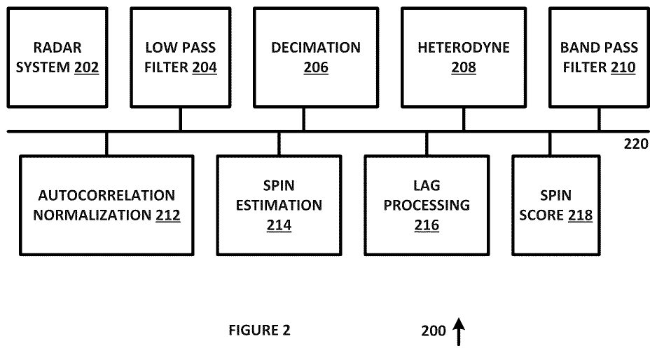

FIG. 2 is a diagram of a system 200 for spin detection, in accordance with an example embodiment of the present disclosure. System 200 includes radar system 202, filter 204, decimation system 206, heterodyne system 208, band pass filter system 210, autocorrelation normalization system 212, spin estimation system 214, lag processing system 216 and spin score system 218, which communicate over data communications medium 220 and which can be implemented in hardware or a suitable combination of hardware and software.

Radar system 202 can be implemented using a signal antenna that transmits electromagnetic radiation towards one or more objects and that receives reflected electromagnetic radiation from the one or more objects. In one example embodiment, radar system 202 can be a continuous wave Doppler radar that transmits and receives analog signals and that converts the analog signals to digital signals for data processing, such as described in U.S. Pat. Nos. 5,528,245; 5,563,603; 5,525,996; 5,570,093; 5,565,871; 7,227,494; 7,038,614; 8,138,966; 7,864,102; 8,378,884; 5,691,724; 6,198,427; 6,646,591; 7,068,212; 6,744,379; 6,580,386; 6,831,593; 7,411,544; 6,853,314; 7,068,212, 7,218,271 and 12,066,534, each of which are hereby incorporated by reference for all purposes as if set forth herein in their entireties.

Low pass filter 204 can be implemented as one or more algorithms stored in a data memory device of a processor that configure the processor to receive digital data samples and to perform low pass filtering of the digital data samples. In one example embodiment, the digital data samples can include a plurality of frequency bins and low pass filter 204 can remove predetermined frequency bins from the digital data samples.

Decimation system 206 can be implemented as one or more algorithms stored in a data memory device of a processor that configure the processor to receive digital data samples and to perform decimation of the digital data samples. In one example embodiment, the digital data samples can be generated at a first data rate and decimation system 206 can remove one or more samples to reduce the data rate.

Heterodyne system 208 can be implemented as one or more algorithms stored in a data memory device of a processor that configure the processor to receive digital data samples and to perform heterodyne processing of the digital data samples. In one example embodiment, the digital data samples can include a plurality of frequency bins and heterodyne system 208 can receive a complex signal x(t) and can mix the signal with a complex signal c(t) that is generated to specifically nullify the frequency shift (chirp) seen in the original x(t).

Band pass filter system 210 can be implemented as one or more algorithms stored in a data memory device of a processor that configure the processor to receive digital data samples and to perform band pass filtering of the digital data samples. In one example embodiment, the digital data samples can include a plurality of frequency bins and band pass filter 210 can remove predetermined frequency bins from the digital data samples.

Autocorrelation normalization 212 be system can implemented as one or more algorithms stored in a data memory device of a processor that configure the processor to receive digital data samples and to perform autocorrelation normalization of the digital data samples. In one example embodiment, the digital data samples can include a plurality of frequency bins and autocorrelation normalization 212 can perform autocorrelation of the digital data samples and can normalize the autocorrelated digital data samples, as discussed and described herein or in other suitable manners.

Spin estimation system 214 can be implemented as one or more algorithms stored in a data memory device of a processor that configure the processor to receive digital data samples and to perform spin estimation of the digital data samples. In one example embodiment, the digital data samples can include a plurality of frequency bins and spin estimation system 214 can process the digital data samples to generate spin estimates as discussed and described herein or in other suitable manners.

Lag processing system 216 can be implemented as one or more algorithms stored in a data memory device of a processor that configure the processor to receive digital data samples and to perform lag processing of the digital data samples. In one example embodiment, the digital data samples can include a plurality of frequency bins and lag processing system 216 can perform lag processing, as discuss and described herein or in other suitable manners.

Spin score system 218 can be implemented as one or more algorithms stored in a data memory device of a processor that configure the processor to receive digital data samples and to perform spin scoring of the digital data samples. In one example embodiment, the digital data samples can include a plurality of frequency bins and spin score system 218 can perform spin scoring as discussed and described herein or in other suitable manners.

Data communications medium 220 can be implemented in hardware or a suitable combination of hardware and software and can be a suitable data bus or buses. In one example embodiment, data communications medium can be an RS-232 bus, a DALI bus, an SPI bus, a CAN bus, an I²C bus, a UNI/O bus, a 1-Wire bus, a USB, a SATA bus, a PCI Express, other suitable data communications media or a suitable combination of data communications media.

In one example embodiment, a method for determining spin of an object is provided that includes transmitting an electromagnetic signal towards the object from a transmitter, receiving a reflected signal from the object, performing a correlation process on the reflected signal using the reflected signal to generate a plurality of estimates of a spin of the object, determining an average of the plurality of the estimates of the spin of the object, normalizing the average of the plurality of the estimates of the spin of the object and generating an estimate of the spin of the object as a function of the normalized average of the plurality of the estimates of the spin of the object, as discussed and described further herein.

In another example embodiment, the method of includes finding a lag of the plurality of the estimates of the spin of the object and using the lag to estimate the spin of the object.

In another example embodiment, the method includes finding a lag of the plurality of the estimates of the spin of the object having a greatest energy and using the lag with the greatest energy to estimate the spin of the object. In another example embodiment, the method includes generating a score of the estimate of the spin of the object and using the estimate of the spin of the object if the score is greater than a threshold.

In another example embodiment, performing the correlation process on the reflected signal comprises comparing a first spectrum of reflected signal from the object from a first time with a second spectrum of reflected signal from the object from a second time, wherein the second time is different from the first time, to determine a spin rate in revolutions per minute.

In another example embodiment, performing the correlation process on the reflected signal comprises comparing a first spectrum from a reflected signal from the object with a second spectrum from the reflected signal from the object to identify a metric from the first spectrum in the second spectrum.

In another example embodiment, performing the correlation process on the reflected signal comprises comparing a first spectrum of frequency data from a reflected signal from the object with a second spectrum of frequency data from the reflected signal from the object to identify a matching pattern.

In another example embodiment, the method includes generating an estimate of the spin of the object as a function of shoulder frequencies using calibration data that specifies a known shoulder width associated with a known spin of the object.

In another example embodiment, the method includes generating a score as a function of the estimate of the spin of the object as the function of the shoulder frequencies and the estimate of the spin of the object as the function of the correlation process.

In another example embodiment, a system for determining spin of an object is disclosed that includes a radar system transmitting a signal towards the object, a peak detection system configured to identify a component spectrum of a reflected signal and at least one shoulder frequency, and a correlation system configured to perform a correlation process on the reflected signal and the shoulder frequency using the component spectrum to generate a plurality of estimates of the spin of the object, to determine an average of the plurality of the estimates of the spin of the object, to normalize the average of the plurality of the estimates of the spin of the object and to generate an estimate of the spin of the object as a function of the normalized average of the plurality of the estimates of the spin of the object, as discussed and described further herein.

In another example embodiment, the correlation system is further configured to find a lag of the plurality of the estimates of the spin of the object and to use the lag to estimate the spin of the object.

In another example embodiment, the correlation system is further configured to find a lag of the plurality of the estimates of the spin of the object having a greatest energy and to use the lag with the greatest energy to estimate the spin of the object.

In another example embodiment, the correlation system is further configured to generate a score of the estimate of the spin of the object and to use the estimate of the spin of the object if the score is greater than a threshold.

In another example embodiment, the system further includes a time to frequency domain transform system configured to transform the reflected signal from the time domain to a frequency domain by performing a Fourier transform on the reflected signal.

In another example embodiment, the peak detection system is configured to detect a frequency component of the reflected signal that has a greater magnitude than a magnitude of other frequency components of the reflected signal.

In another example embodiment, the correlation system is configured to compare a first set of the reflected signals from the object with a second set of the reflected signals from the object.

In another example embodiment, the correlation system is configured to compare a first set of reflected signals from the object from a first time with a second set of reflected signal from the object from a second time, wherein the second time is different from the first time.

In another example embodiment, the correlation system is configured to compare a first set of peaks from a reflected signal from the object with a second set of peaks from the reflected signal from the object.

In another example embodiment, the correlation system is configured to compare a first set of frequency data from a reflected signal from the object with a second set of frequency data from the reflected signal from the object.

In another example embodiment, the system includes a shoulder detection system configured to identify shoulder frequencies in the reflected signal.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general-purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general-purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for determining spin of an object comprising:
transmitting an electromagnetic signal towards the object from a transmitter;
receiving a reflected signal from the object;
performing a correlation process on the reflected signal using the reflected signal to generate a plurality of estimates;
normalizing the plurality of the estimates; and
generating an estimate of the spin of the object as a function of the normalized plurality of the estimates.

2. The method of claim 1 further comprising:
finding a lag of the plurality of the estimates; and
using the lag to estimate the spin of the object.

3. The method of claim 1 further comprising:
finding a lag of the plurality of the estimates having a greatest energy; and
using the lag with the greatest energy to estimate the spin of the object.

4. The method of claim 1 further comprising:
generating a score of the estimate of the spin of the object; and
using the estimate of the spin of the object if the score is greater than a threshold.

5. The method of claim 1 wherein performing the correlation process on the reflected signal comprises comparing a first spectrum of reflected signal from the object from a first time with a second spectrum of reflected signal from the object from a second time, wherein the second time is different from the first time, to determine a spin rate in revolutions per minute.

6. The method of claim 1 wherein performing the correlation process on the reflected signal comprises comparing a first spectrum from a reflected signal from the object with a second spectrum from the reflected signal from the object to identify a metric from the first spectrum in the second spectrum.

7. The method of claim 1 wherein performing the correlation process on the reflected signal comprises comparing a first spectrum of frequency data from a reflected signal from the object with a second spectrum of frequency data from the reflected signal from the object to identify a matching pattern.

8. The method of claim 1 further comprising generating an estimate of the spin of the object as a function of shoulder frequencies using calibration data that specifies a known shoulder width associated with a known spin of the object.

9. The method of claim 8 further comprising generating a score as a function of the estimate of the spin of the object as the function of the shoulder frequencies and the estimate of the spin of the object as the function of the correlation process.

10. A system for determining spin of an object comprising:
a radar system transmitting a signal towards the object;
a peak detection system configured to identify a component spectrum of a reflected signal; and
a correlation system configured to perform a correlation process on the reflected signal and the shoulder frequency using the component spectrum to generate a plurality of estimates, to normalize the plurality of the estimates and to generate an estimate of the spin of the object as a function of the normalized plurality of the estimates.

11. The system of claim 10 wherein the correlation system is further configured to find a lag of the plurality of the estimates and to use the lag to estimate the spin of the object.

12. The system of claim 10 wherein the correlation system is further configured to find a lag of the plurality of the estimates having a greatest energy and to use the lag with the greatest energy to estimate the spin of the object.

13. The system of claim 10 wherein the correlation system is further configured to generate a score of the estimate of the spin of the object and to use the estimate of the spin of the object if the score is greater than a threshold.

14. The system of claim 10 further comprising a time to frequency domain transform system configured to transform the reflected signal from the time domain to a frequency domain by performing a Fourier transform on the reflected signal.

15. The system of claim 10 wherein the peak detection system is configured to detect a frequency component of the reflected signal that has a greater magnitude than a magnitude of other frequency components of the reflected signal.

16. The system of claim 10 wherein the correlation system is configured to compare a first set of the reflected signals from the object with a second set of the reflected signals from the object.

17. The system of claim 10 wherein the correlation system is configured to compare a first set of reflected signals from the object from a first time with a second set of reflected signal from the object from a second time, wherein the second time is different from the first time.

18. The system of claim 10 wherein the correlation system is configured to compare a first set of peaks from a reflected signal from the object with a second set of peaks from the reflected signal from the object.

19. The system of claim 10 wherein the correlation system is configured to compare a first set of frequency data from a reflected signal from the object with a second set of frequency data from the reflected signal from the object.

20. The system of claim 10 further comprising a shoulder detection system configured to identify shoulder frequencies in the reflected signal.
